(19) United States
(12) Patent Application Publication
(10) Pub. No.: US 2012/0019597 A1
(43) Pub. Date: Jan. 26, 2012

(54) INKJET PRINTHEAD WITH CROSS-SLOT CONDUCTOR ROUTING

(75) Inventors: Chien-Hua Chen, Corvallis, OR (US); Thomas R. Strand, Corvallis, OR (US); Ricky L. Brenneman, Corvallis, OR (US)

(73) Assignee: HEWLETT-PACKARD DEVELOPMENT COMPANY, L.P., Houston, TX (US)

(21) Appl. No.: 13/258,690

(22) PCT Filed: Oct. 8, 2009
(86) PCT No.: PCT/US2009/059995

§ 371 Date: Sep. 22, 2011

(51) Int. Cl. B41J 2/135; B23P 17/00

(52) U.S. Cl. 347/44; 29/890.1

(57) ABSTRACT

An inkjet printhead includes a substrate having an ink slot formed through its center. Integrated circuitry is formed on both a first side and a second side of the center ink slot. A conductor trace is routed across the ink slot to provide electrical communication between the integrated circuitry on the first and second sides of the slot.

### BACKGROUND

Conventional drop-on-demand inkjet printers are commonly categorized based on one of two mechanisms of drop formation. A thermal bubble inkjet printer uses a heating element actuator (a thin film resistive heater element) in an ink-filled chamber to vaporize ink and create a bubble which forces an ink drop out of a nozzle. A piezoelectric inkjet printer uses a piezoelectric material actuator on a wall of an ink-filled chamber to generate a pressure pulse which forces a drop of ink out of the nozzle.

Common to both of these inkjet actuator types is a printhead substrate (i.e., printhead die) that contains a plurality of conductive traces that make electrical connections to respective ink ejection elements on the substrate (i.e., the heating element actuators and piezoelectric material actuators). A typical printhead substrate has multiple elongated ink slots, and the conductive traces are routed along the ink slots to the ends of the substrate to make interconnections with a controller. The controller applies electrical energy to the conductor traces to selectively activate the ink ejection elements, which causes the ejection of ink droplets through corresponding ink nozzles resulting in the formation of text and images on a print medium.

Reducing the costs of inkjet printhead substrates while increasing the density of ejection elements on the substrates is an ongoing objective in the design of inkjet printheads. Efficient routing of the conductor traces in inkjet printheads is an important factor that can impact the ongoing efforts to reduce substrate size and costs.

### BRIEF DESCRIPTION OF THE DRAWINGS

The present embodiments will now be described, by way of example, with reference to the accompanying drawings, in which:

FIG. 1 shows an example of an inkjet printhead having conductor traces that cross over a center ink slot, according to an embodiment;

FIG. 2 shows a top-down view of an example of an inkjet printhead having conductor traces that cross over a center ink slot, according to an embodiment;

FIG. 3 shows an example of an inkjet printhead having conductor traces that cross over a center ink slot and that are embedded within an SU8 orifice layer below a top-hat layer, according to an embodiment;

FIG. 4 shows an example of an inkjet printhead having conductor traces that cross over a center ink slot and that are embedded within an SU8 orifice layer above a top-hat layer, according to an embodiment;

FIGS. 5-8 show an inkjet printhead in various phases of fabrication according to an embodiment.

FIG. 9 shows a flowchart of a method of fabricating an inkjet printhead, according to an embodiment.

Throughout the drawings, identical reference numbers designate similar, but not necessarily identical, elements.

### DETAILED DESCRIPTION

### Overview of Problem and Solution

As noted above, efficient routing of conductor traces in inkjet printheads is an important factor that can impact the size and cost of the printhead substrate (i.e., printhead die). In the art of inkjet printing, it is generally well-known to fabricate integrated circuitry, conductor traces, ejection elements, and other substrate features onto the printhead substrate through various precision microfabrication techniques such as electroforming, laser ablation, anisotropic etching, and photolithography.

Currently, the routing of conductor traces on the substrate between ink ejection elements (e.g., resistive heater elements in thermal bubble inkjet printers; piezoelectric material actuators in piezoelectric inkjet printers) and circuitry or interconnects on the substrate is accomplished by routing the traces along the ink slots to the ends of the substrate. Therefore, although there are ink chambers and ejection elements on either side of an ink slot that may use the same ground and signal lines, there is no sharing of the ground or other electrical signals across the ink slot. The ink slot supplies ink to the ink chambers through the back side of the substrate and therefore acts as a barrier between conductor traces and other circuitry formed in the substrate on either side of the ink slot. Thus, conductor traces are routed to the ends of the substrate, around the ink slot, to complete electrical signal paths (e.g., ground connections) and off-substrate interconnections.

One disadvantage with this electrical routing and interconnection technique is that it can impose a limiting factor on the ability to reduce the size of the substrate. As the density of ink chambers along either side of an ink slot increases, so too must the number of conductor traces routed along the sides of the ink slots that are needed to activate the ink ejection elements in those chambers. Another disadvantage with the present electrical routing and interconnection technique is that it limits the substrate interconnects to the ends of the substrate and makes interconnects at the edges of the substrate difficult. This in turn can limit the flexibility in designing more efficient off-substrate interconnects, such as different types of tape automated bonding (“flex tape”).

Embodiments of the present disclosure overcome disadvantages such as those mentioned above through the use of conductor traces that cross over the ink slot in an inkjet printhead substrate. The cross-slot conductor traces enable the sharing of common electrical signal traces (e.g., common ground trace) between ejection elements (e.g., resistive heater elements; piezoelectric material actuators) on either side of the ink slot. The cross-slot conductor traces provide for simplified routing of conductor traces through a more direct routing across the ink slot rather than routing along the ink slots to the ends of the substrate. The simplified routing enables easier side connections to the printhead substrate for electrical signal transmission and adds functionality to the printhead orifice layer.

In one embodiment, for example, an inkjet printhead includes a substrate having an ink slot formed through its center. A conductor trace is routed across the ink slot to provide electrical communication between the integrated circuitry on both sides of the slot. In different embodiments the conductor trace is embedded in various places within an SU8 orifice layer formed on the substrate. In one embodiment, an inkjet printhead includes a via formed in an SU8 orifice layer through which the conductor trace extends from the SU8 orifice layer to integrated circuitry on the substrate. In another embodiment, a method of fabricating an inkjet printhead includes forming an SU8 chamber layer on a printhead die and laminating an SU8 top hat layer over the SU8 chamber layer with a metal trace formed on the SU8 top hat layer. In another embodiment, an SU8 cap layer is formed over the top hat layer, embedding the metal trace between the top hat layer and the cap layer.

### Illustrative Embodiments

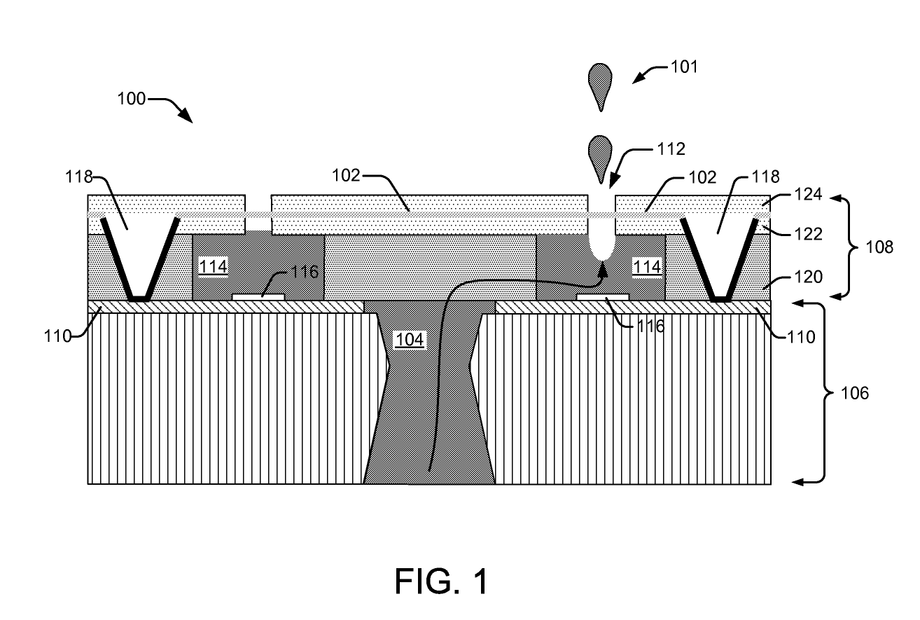

FIG. 1 shows a side view of an example fluid ejection head 100 (e.g., an inkjet printhead) having conductor traces 102 that cross over a center ink slot 104, according to an embodiment. One example of a fluid ejection head 100 is an inkjet printhead 100 in an inkjet printing system (not shown). In general, and as well-known to those skilled in the art, an inkjet printhead 100 ejects ink droplets 101 through a plurality of orifices or nozzles toward a print medium, such as a sheet of paper, to print an image onto the print medium. The nozzles are typically arranged in one or more arrays, such that properly sequenced ejection of ink from the nozzles causes characters or other images to be printed on the print medium as the printhead and the print medium are moved relative to each other.

The operating mechanism of a conventional inkjet printhead 100 is commonly classified based on its ink ejection element as either thermal bubble or piezoelectric. In a typical thermal bubble inkjet printing system, the printhead ejects ink drops through nozzles by rapidly heating small volumes of ink located in ink chambers. The ink ejection elements are small electric heaters, such as thin film resistors sometimes referred to as firing resistors. Application of a voltage potential across the firing resistor heats the ink and causes the ink to vaporize and be ejected through the nozzles. In a piezoelectric inkjet printing system, the ink ejection elements are piezoelectric material actuators. The piezoelectric printhead ejects ink drops through nozzles by generating pressure pulses in the ink within the chamber, forcing drops of ink from the nozzle. The pressure pulses are generated by changes in shape or size of a piezoelectric material when a voltage is applied across the material. Although reference is made herein primarily to a conventional inkjet printhead 100 of the thermal bubble or piezoelectric type, it is noted that printhead 100 may comprise any other type of device configured to selectively deliver or eject a fluid onto a medium through a nozzle.

Referring again to FIG. 1, the inkjet printhead 100 generally includes a substrate layer such as a silicon substrate 106, and an orifice layer 108. An integrated circuit layer 110 is fabricated on the silicon substrate 106 between the substrate 106 and the orifice layer 108. The substrate 106 includes the ink channel/slot 104 for supplying ink or other fluid to the orifice layer 108 and nozzle(s) 112. The orifice layer 108 is an SU8 layer that includes a chamber 114 (e.g., an ink firing chamber) and nozzle 112. Activation of an ink ejection element 116 (e.g., resistive heater element, piezoelectric material actuator) within chamber 114 ejects ink droplets 101 through the nozzle 112.

Conductor traces 102 can be embedded within the SU8 orifice layer 108 in various ways as discussed below. Conductor traces 102 can extend across the ink slot 104 to provide, for example, sharing of common traces between the ink ejection elements 116 on both sides of the ink slot 104. The embedded conductor traces 102 can be electrically coupled to integrated circuitry 110 on substrate 106. In some embodiments the embedded conductor traces 102 extend through vias 118 formed in the SU8 orifice layer 108. For example, in the embodiment shown in FIG. 1, the inkjet printhead 100 includes vias 118 formed through the SU8 orifice layer 108 that permit the embedded conductor traces 102 to pass through the SU8 orifice layer 108 and contact integrated circuitry 110 on the silicon substrate 106. Thus, conductor traces 102 can carry electrical signals from one side of the printhead 100 to the other, across the ink slot 104, between integrated circuitry 110, ink ejection elements 116, electrical interconnections at the edges of the printhead 100, and so on.

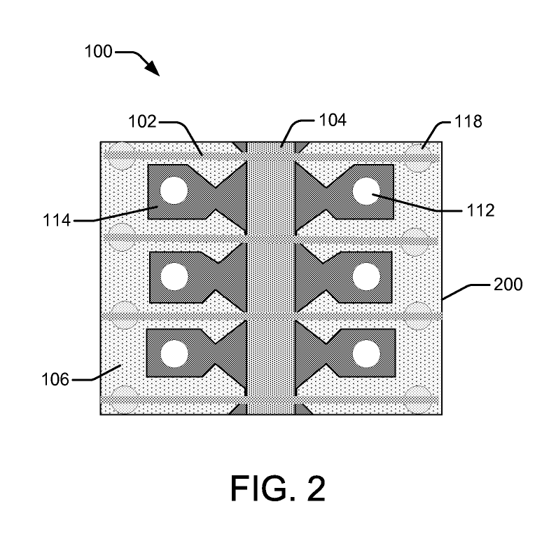

FIG. 2 shows a top-down view of an example inkjet printhead 100 having conductor traces 102 that cross over a center ink slot 104, according to an embodiment. Although the side view of printhead 100 in FIG. 1 appears to show conductor trace 102 crossing over nozzles 112, the top-down view in FIG. 2 clarifies that conductor traces 102 can run across the ink slot 104 in the spaces between nozzles 112. However, the routing of the conductor traces 102 within the SU8 orifice layer 108 is not limited to any particular layout as might be illustrated herein. Rather, this disclosure contemplates the routing of the conductor traces 102 within the SU8 orifice layer 108 in any appropriate manner or layout that may facilitate functionality of the printhead 100, efficient use of space on the printhead 100, or any other benefit that may be derived from the conductor traces 102 being embedded within the SU8 orifice layer 108. For example, in some embodiments a conductor trace 102 may intersect a nozzle 112 and be broken or divided by the gap across the nozzle 112 for purpose of enabling an ink drop sensing capability in the printhead 100 through the two remaining sections of the divided conductor acting as probes intersecting the nozzle 112. In other embodiments, conductor traces 102 may extend to the edges 200 of the printhead 100 for the purpose of engaging electrical edge interconnects (not shown) on the printhead 100, such as tape automated bonding (“flex tape”).

Referring again to FIG. 1, the SU8 orifice layer 108 may be composed of more than a single layer of SU8. As shown in the FIG. 1 embodiment, the SU8 orifice layer 108 is composed of a first SU8 chamber layer 120, a second SU8 “top-hat” layer 122, and a third SU8 “cap” layer 124. In this configuration the embedded conductor traces 102 are embedded within the SU8 orifice layer 108 between the top-hat layer 122 and cap layer 124. However, depending on the fabrication process flow, the conductor traces 102 in other embodiments may be placed variously within the SU8 orifice layer 108, such as beneath the top-hat layer 122, inside the top-hat layer 122, between the top-hat layer 122 and a cap layer 124, or on top of the top-hat layer 122 without a cap layer 124. In addition, the shape of the conductor traces 102 can be defined (e.g., photo-defined, etc.) in the fabrication process so that it is possible to make traces with different sizes, lengths, and shapes.

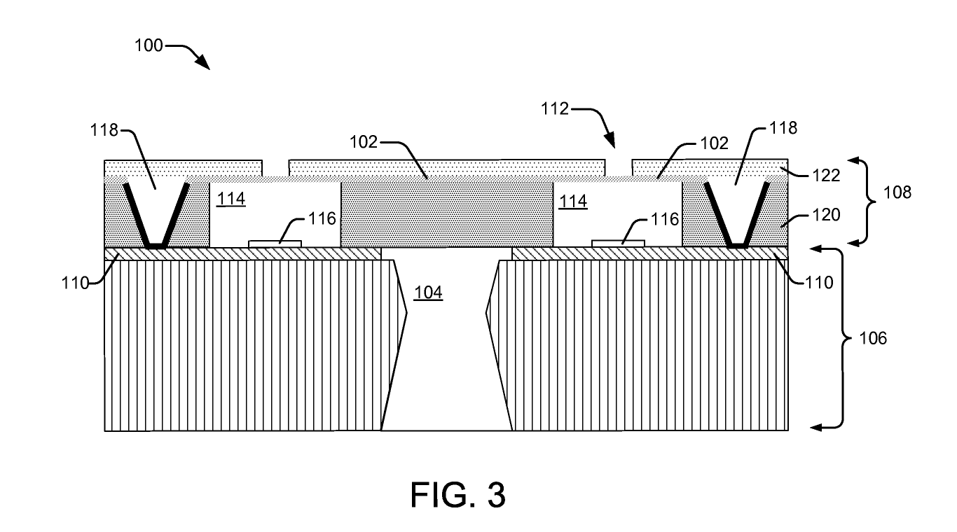

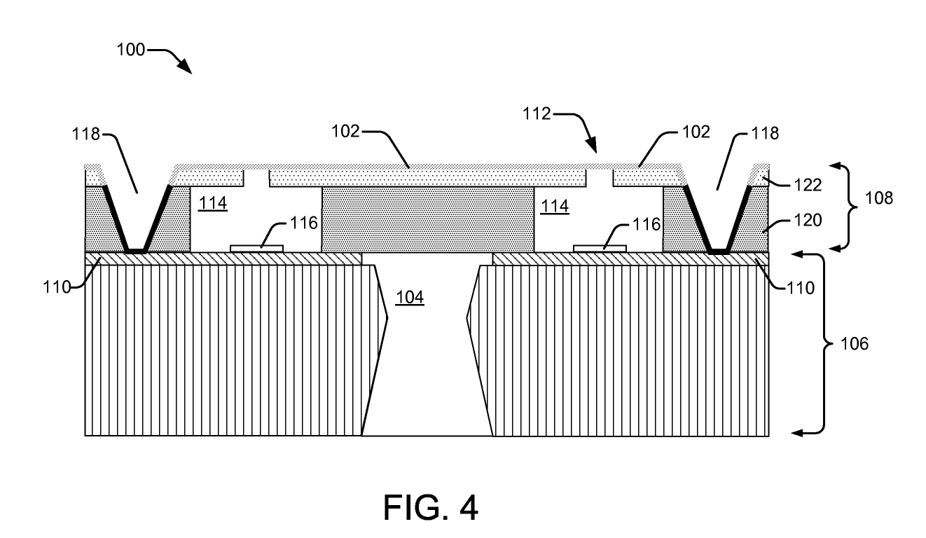

FIG. 3 shows a side view of an example fluid ejection head 100 (e.g., an inkjet printhead) having conductor traces 102 that cross over a center ink slot 104 and are embedded within the SU8 orifice layer 108 below the top-hat layer 122, according to an embodiment. In this embodiment, the SU8 orifice layer 108 includes a first chamber layer 120 and a second top-hat layer 122, but does not include a third cap layer 124. FIG. 4 shows a side view of an example fluid ejection head 100 (e.g., an inkjet printhead) having conductor traces 102 that cross over a center ink slot 104 and are embedded within the SU8 orifice layer 108 above the top-hat layer 122, according to an embodiment. In this embodiment, the SU8 orifice layer 108 includes a first chamber layer 120 and a second top-hat layer 122, but does not include a third cap layer 124.

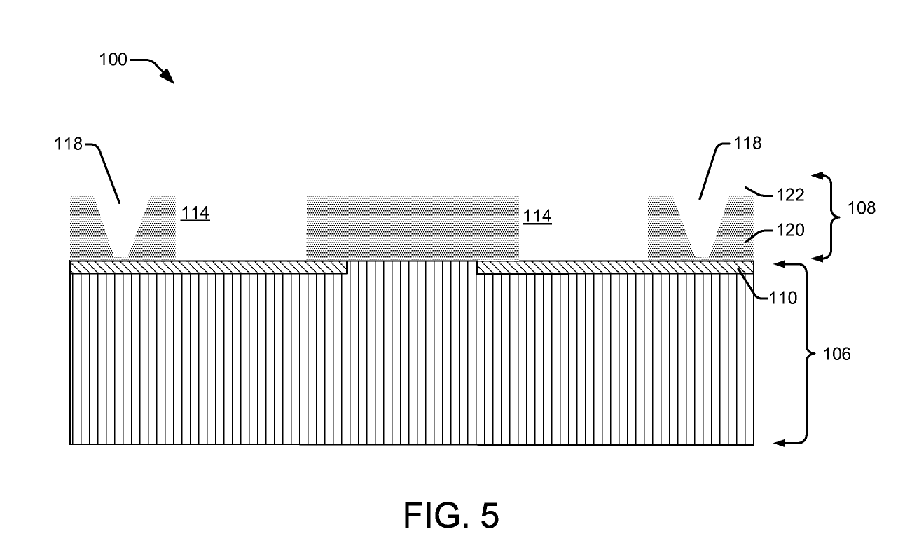

FIGS. 5-8 illustrate an inkjet printhead 100 in various phases of fabrication according to an embodiment. The fabrication of the inkjet printhead 100 can be performed using various well-known precision microfabrication techniques such as electroforming, laser ablation, anisotropic etching, and photolithography. In FIG. 5, an SU8 chamber layer 120 is applied to a substrate 106 (printhead die) such as a silicon wafer. The SU8 chamber layer 120 forms one or more chambers 114 and one or more vias 118. Prior to the application of the SU8 chamber layer 120, an integrated circuit layer 110 has already been fabricated on the silicon substrate 106 through well-known techniques such as photolithography. The SU8 chamber layer 120 can be applied to the substrate, for example, through spin-coating.

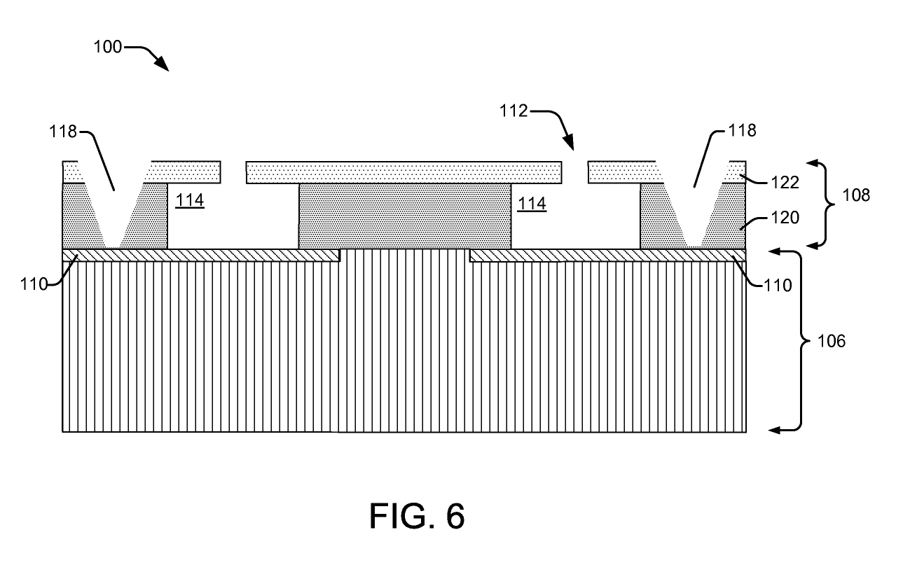

In FIG. 6, an SU8 top hat layer 122 is applied over the SU8 chamber layer 120. The top hat layer 122 can be applied, for example, as a laminate dry film SU8 top hat layer 122 through known microfabrication techniques. Application of the SU8 top hat layer 122 forms nozzle openings 112 over respective chambers 114 and may further form the vias 118 to extend through the SU8 top hat layer 122. Together, the chamber layer 120 and top hat layer 122, may in some embodiments be referred to as SU8 orifice layer 108.

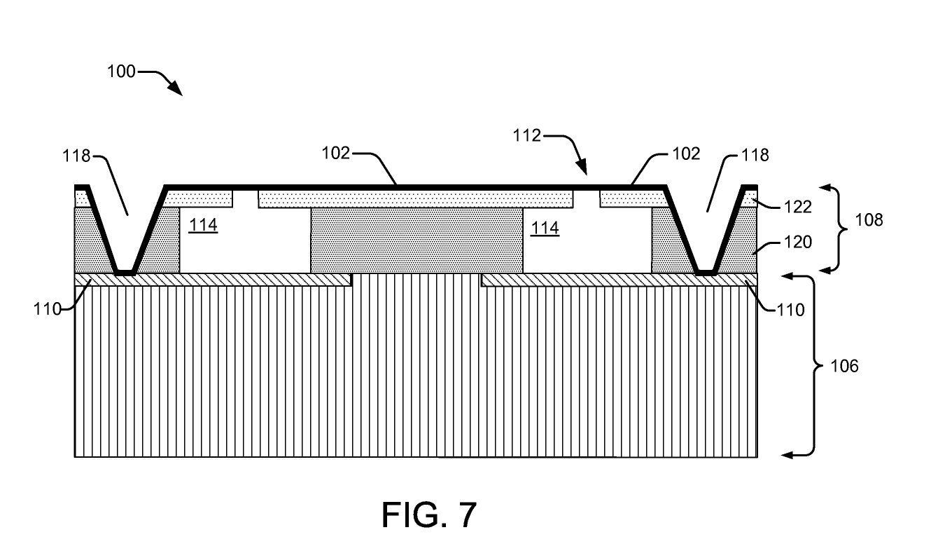

In FIG. 7, a metal trace referred to as a conductor trace 102 is applied on top of the SU8 top hat layer 122, for example, through known circuit microfabrication techniques. As noted above, conductor trace 102 may be fabricated within the SU8 orifice layer 108 in various locations. For example, depending on the fabrication process flow, the conductor traces 102 in other embodiments may be placed variously within the SU8 orifice layer 108, such as beneath the top-hat layer 122, inside the top-hat layer 122, between the top-hat layer 122 and a cap layer 124, or on top of the top-hat layer 122 without a cap layer 124. Accordingly, although FIGS. 5-7 illustrate one embodiment of a fabrication process wherein the conductor trace 102 is applied on top of the SU8 top hat layer 122, other embodiments having the conductor trace 102 in other locations within the SU8 orifice layer are contemplated.

Although the conductor trace 102 in FIG. 7 appears to be crossing over nozzles 112, the conductor traces 102 can be routed across the ink slot 104 in the spaces between nozzles 112. The routing of the conductor traces 102 on the SU8 top hat layer 122 or otherwise within the SU8 orifice layer 108 is not limited to any particular layout. Rather, as noted above, the routing of the conductor traces 102 within the SU8 orifice layer 108 can be fabricated using any appropriate layout that may facilitate functionality of the printhead 100, efficient use of space on the printhead 100, or any other benefit that may be derived from the conductor traces 102 being embedded within the SU8 orifice layer 108.

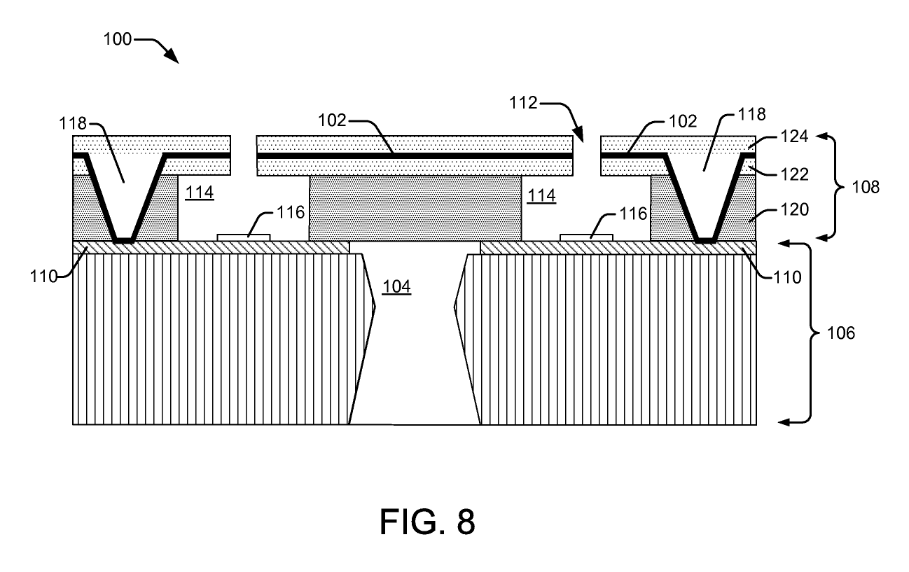

In FIG. 8, a cap layer 124 is applied over the top hat layer 122. The cap layer 124 can be applied, for example, as a laminate dry film SU8 cap layer 124. Together, the chamber layer 120, top hat layer 122 and cap layer 124, may in some embodiments be referred to as SU8 orifice layer 108. Application of the cap layer 124 embeds the conductor trace 102 in the SU8 orifice layer 108. FIG. 8 further illustrates additional fabrication of the substrate 106 to include an ink channel 104 for supplying ink or other fluid to the SU8 orifice layer 108, ink ejection elements 116, and nozzles 112.

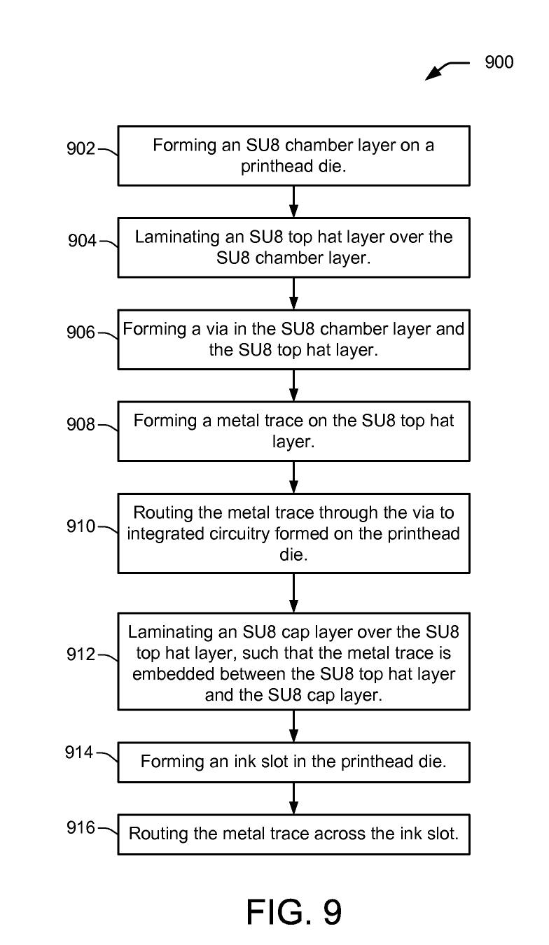

FIG. 9 shows a flowchart of a method 900 of fabricating an inkjet printhead, according to an embodiment. Method 900 is associated with the embodiments of an inkjet printhead 100 illustrated in FIGS. 1-8 and the related description above. Although method 900 includes steps listed in certain order, it is to be understood that this does not limit the steps to being performed in this or any other particular order. In general, the steps of method 900 may be performed using various precision microfabrication techniques such as electroforming, laser ablation, anisotropic etching, and photolithography, as are well-known to those skilled in the art.

Method 900 begins at block 902 with forming an SU8 chamber layer on a printhead die (silicon substrate). The SU8 chamber includes fluid chambers and vias, and is typically formed by spin-coating the SU8 onto the substrate. Generally, prior to the formation of the SU8 chamber layer, an integrated circuit layer has been fabricated into the printhead die. At block 904 of method 900, an SU8 top hat layer is laminated over the SU8 chamber layer. The top hat layer is applied as a laminate dry film SU8 top hat layer that forms nozzle openings over respective chambers in the chamber layer, and may further extend the formation of the vias in the chamber layer. As an alternative, the chambers 114 and vias 118 in the chamber layer 124 can be filled with lost wax material prior to the top hat layer lamination process to keep the top hat layer flat. The lost was in vias can be developed away with photo and etch processes prior to conductive trace deposition.

Method 900 continues at block 906 where the vias are formed in the SU8 chamber layer and SU8 top hat layer as mentioned in blocks 902 and 904. At block 908, a metal conductive trace is formed on the SU8 top hat layer. However, depending on the order of fabrication process steps, the conductor trace may be fabricated within the SU8 orifice layer in various locations, such as beneath the top-hat layer, inside the top-hat layer, between the top-hat layer and a cap layer, or on top of the top-hat layer without a cap layer. At block 910 the metal conductive trace is routed through the via from the SU8 orifice layer to integrated circuitry formed on the printhead die/substrate.

At block 912 of method 900, an SU8 cap layer is laminated over the SU8 top hat layer, such that the metal trace is embedded between the SU8 top hat layer and the SU8 cap layer. At block 914 an ink slot is formed in the printhead die/substrate, and the metal conductive trace is routed across the ink slot at block 916.

What is claimed is:

1. An inkjet printhead comprising:
a substrate having an ink slot formed through its center and integrated circuitry on first and second sides of the slot; and
a conductor trace routed across the ink slot to provide electrical communication between the integrated circuitry on the first and second sides of the slot.

2. An inkjet printhead as in claim 1, wherein the conductor trace is embedded in an SU8 orifice layer formed on the substrate.

3. An inkjet printhead as in claim 2, wherein the SU8 orifice layer comprises:
a chamber layer formed on the substrate;
a laminate SU8 top layer formed on the chamber layer; and
a laminate SU8 cap layer formed on the top layer, wherein the conductor trace is embedded between the top layer and the cap layer.

4. An inkjet printhead as in claim 2, further comprising a via formed in the SU8 orifice layer through which the conductor trace extends from the SU8 orifice layer to integrated circuitry on the substrate.

5. An inkjet printhead as in claim 1, further comprising an SU8 chamber layer formed on the substrate wherein the conductor trace is routed on top of the SU8 chamber layer.

6. An inkjet printhead as in claim 1, further comprising:
an SU8 chamber layer formed on the substrate; and
an SU8 top layer formed on the SU8 chamber layer, wherein the conductor trace is routed on top of the SU8 top layer.

7. An inkjet printhead as in claim 6, further comprising an SU8 cap layer formed on the SU8 top layer wherein the conductor trace is embedded between the SU8 cap layer and the SU8 top layer.

8. An inkjet printhead as in claim 1, wherein the SU8 orifice layer comprises an ink chamber and an ink nozzle.

9. An inkjet printhead as in claim 1, wherein the integrated circuitry comprises an ink ejection mechanism selected from a resistive heater element and a piezoelectric element activated by an electrical current applied through the conductor trace.

10. An inkjet printhead as in claim 1, wherein the conductor trace is further routed to an edge of the substrate.

11. A method of fabricating an inkjet printhead comprising:
forming an SU8 chamber layer on a printhead die;
laminating an SU8 top hat layer over the SU8 chamber layer; and
forming a metal trace on the SU8 top hat layer.

12. A method as recited in claim 11, further comprising:
laminating an SU8 cap layer over the SU8 top hat layer, such that the metal trace is embedded between the SU8 top hat layer and the SU8 cap layer.

13. A method as recited in claim 11, further comprising:
forming an ink slot in the printhead die;
wherein forming a metal trace on the SU8 top hat layer comprises routing the metal trace across the ink slot.

14. A method as recited in claim 11, further comprising:
forming an ink slot in the printhead die;
wherein forming a metal trace comprises forming the metal trace underneath the SU8 top hat layer and routing the metal trace across the ink slot.

15. A method as recited in claim 11, further comprising:
forming a via in the SU8 chamber layer and the SU8 top hat layer;
wherein forming a metal trace on the SU8 top hat layer comprises routing the metal trace through the via to integrated circuitry formed on the printhead die.
